(19) United States
(12) Patent Application Publication
(10) Pub. No.: US 2025/0129451 A1
(43) Pub. Date: Apr. 24, 2025

(54) COPPER ALLOYS FOR ELECTRONIC MATERIALS AND ELECTRONIC COMPONENTS

(71) Applicant: JX Advanced Metals Corporation, Tokyo (JP)

(72) Inventor: Yuta NAKAMURA, Ibaraki (JP)

(73) Assignee: JX Advanced Metals Corporation, Tokyo (JP)

(21) Appl. No.: 18/730,259

(22) PCT Filed: Jan. 25, 2023
(86) PCT No.: PCT/JP2023/002300

§ 371 Date: Jul. 18, 2024

(30) Foreign Application Priority Data
Feb. 1, 2022 (JP) 2022-014415

(51) Int. Cl. C22C 9/06; H01B 1/02

(52) U.S. Cl. CPC C22C 9/06; H01B 1/026

(57) ABSTRACT

A copper alloy for electronic materials, in which an amount of Ni is 1.0% by mass or less, the copper alloy including 0.5 to 2.5% by mass of Co, and including Si such that a mass ratio (Ni+Co)/Si is 3 to 5, the remainder consisting of copper and inevitable impurities, wherein an average Taylor factor under plane strain that elongates in a direction perpendicular to a rolling direction and reduces plate thickness is 3.5 or less, a crystal grain size is 10 μm or less, and a 0.2% yield stress in the rolling direction is 700 MPa or more, and an electrical conductivity in the rolling direction is 50% IACS or more.

### FIELD OF THE INVENTION

The present invention relates to a copper alloy for electronic materials, and electronic components.

### BACKGROUND OF THE INVENTION

Copper alloys for electronic materials used in various electronic components such as connectors, switches, relays, pins, terminals, and lead frames are required to have both high strength and high electrical conductivity as basic characteristics. With the miniaturization of electronic devices in recent years, the substrates and connectors mounted on these devices are also becoming lighter, thinner, shorter and smaller, and the requirements for the properties of copper alloys are becoming higher and higher. In particular, in order to avoid increasing the size of a connector, it is desirable that a copper alloy have a 0.2% yield stress in the rolling direction of 700 MPa or more and an electrical conductivity of 50% IACS or more. Copper alloys are also required to have high bending workability so that the base material can be processed into various connector shapes.

A Cu—Ni—Si alloy, commonly referred to as a Corson alloy, is known as a typical copper alloy that has high strength, electrical conductivity, and bending workability. Such copper alloy is a precipitation hardening type copper alloy, and its strength and electrical conductivity are improved by precipitating fine Ni—Si intermetallic compound particles in the copper matrix. Further, in order to obtain higher electrical conductivity, Cu—Co—Ni—Si alloys and Cu—Co—Si alloys in which part or all of Ni is replaced with Co have also been proposed.

Patent Literature 1 (Japanese Patent No. 5391169) describes a technique for achieving all of strength, electrical conductivity, and bending workability by controlling the crystal grain size and the size of precipitates. Specifically, it discloses a copper alloy material for electrical and electronic components, characterized in that the copper alloy material comprises 0.2 to 2 mass % of Co and 0.05 to 0.5 mass % of Si, and further comprises 0.01 to 0.4 mass % of one or more selected from the group consisting of Fe, Ni, Cr and P, the remainder consisting of Cu and inevitable impurities, wherein a crystal grain size is 3 to 35 μm, and a size of precipitates containing both Co and Si is 5 to 50 nm.

Patent Literature 2 (Japanese Patent No. 6228725) describes a technique for achieving both strength and bending workability by controlling the ratio of crystal orientations including Cube orientation. Specifically, it discloses a Cu—Co—Si alloy having excellent strength and bending workability, comprising 0.5 to 3.0 mass % Co and 0.1 to 1.0 mass % Si, the remainder consisting of copper and inevitable impurities, wherein when performing EBSD (Electron Back Scatter Diffraction) measurement and analyzing the crystal orientations, the area ratio of Cube orientation {001}<100> is 5% or more, the area ratio of Brass orientation {110}<112> is 20% or less, and the area ratio of Copper orientation {112}<111> is 20% or less, and therein a work hardening index is 0.2 or less.

### PRIOR ART

### Patent Literature

[Patent Literature 1] Japanese Patent No. 5391169
[Patent Literature 1] Japanese Patent No. 6228725

### SUMMARY OF THE INVENTION

Meanwhile, in recent years, the shape of connectors has become smaller and more complex than before, and in addition to simple bending, copper alloys are sometimes subjected to more severe bending such as notch bending, 180° close bending, and hammer bending. Conventional copper alloys as described above have room for improvement in meeting the demands for a wide variety of complex processing.

In other words, if a higher degree of bending workability is required, it may be difficult to process the material sufficiently by controlling only the crystal grain size as disclosed in Patent Literature 1 or controlling only the proportion of crystal grains having a specific orientation as in Patent Literature 2.

The present invention has been made in view of the above problems, and in one embodiment, one object of the present invention is to provide a highly reliable copper alloy for electronic materials that has a 0.2% yield stress (YS) and an electrical conductivity (EC) suitable for electronic material applications, and has improved bending workability, and to provide an electronic component equipped with such copper alloy for electronic materials.

As a result of extensive studies, the present inventors have discovered that bending workability can be improved by controlling the average Taylor factor, which is calculated from all crystal orientations that exist in the crystalline texture and is a parameter that represents the ease when the entire material undergoes plastic deformation, to 3.5 or less and controlling the crystal grain size to 10 μm or less, and a copper alloy for electronic materials with excellent strength, electrical conductivity, and bending workability can be obtained by adjusting the 0.2% yield stress to 700 MPa or more and the electrical conductivity to 50% IACS or more. The present invention was completed based on such knowledge, and is exemplified as below.

[1] A copper alloy for electronic materials, in which an amount of Ni is 1.0% by mass or less, the copper alloy comprising 0.5 to 2.5% by mass of Co, and comprising Si such that a mass ratio (Ni+Co)/Si is 3 to 5, the remainder consisting of copper and inevitable impurities, wherein an average Taylor factor under plane strain that elongates in a direction perpendicular to a rolling direction and reduces plate thickness is 3.5 or less, a crystal grain size is 10 μm or less, and a 0.2% yield stress in the rolling direction is 700 MPa or more, and an electrical conductivity in the rolling direction is 50% IACS or more.
[2] The copper alloy for electronic materials according to [1], further comprising at least one selected from Ag, Cr, Mn, Sn, P, B, Zr, Ti, Mg, Al, Fe, and Zn in a total amount of 1.0% by mass or less.
[3] An electronic component, comprising the copper alloy for electronic materials according to [1] or [2].

According to one embodiment of the present invention, it is possible to provide a highly reliable copper alloy for electronic materials that has a 0.2% yield stress (YS) and an electrical conductivity (EC) suitable for electronic material applications, and has improved bending workability, and it is possible to provide an electronic component equipped with such copper alloy for electronic materials.

### DETAILED DESCRIPTION OF THE INVENTION

Hereinafter, embodiments of the present invention will now be described in detail with. It should be understood that the present invention is not intended to be limited to the following embodiments, and any change, improvement or the like of the design may be appropriately added based on ordinary knowledge of those skilled in the art without departing from the spirit of the present invention.

The copper alloy for electronic materials (hereinafter also simply referred to as copper alloy) of the present embodiment has an amount of Ni of 1.0% by mass or less, comprising 0.5 to 2.5% by mass of Co, and comprising Si such that a mass ratio (Ni+Co)/Si is 3 to 5, the remainder consisting of copper and inevitable impurities, wherein an average Taylor factor under plane strain that elongates in a direction perpendicular to a rolling direction and reduces plate thickness is 3.5 or less, a crystal grain size is 10 μm or less, and a 0.2% yield stress in the rolling direction is 700 MPa or more, and an electrical conductivity in the rolling direction is 50% IACS or more. In addition, the term “direction perpendicular to a rolling direction” refers to a direction perpendicular to the direction of rotation of the roll surface during rolling.

### (Amount of Co and Ni)

Co, Ni, and Si are precipitated in the matrix as Co₂Si and Ni₂Si by applying appropriate heat treatment, and high strength can be achieved without reducing electrical conductivity. However, if the Co concentration is less than 0.5% by mass, precipitation hardening will be insufficient and the desired strength will not be obtained even if other components are added. On the other hand, when the Co concentration exceeds 2.5% by mass or when the Ni concentration exceeds 1.0% by mass, although sufficient strength can be obtained, the electrical conductivity, bending workability, and hot workability may deteriorate. The concentrations of Ni and Co are preferably 0.7 to 2.3% by mass for Co and 0.2 to 0.8% by mass for Ni. The upper limit of Co may be 2.2% by mass or less, may be 2.1% by mass or less, may be 2.0% by mass or less, may be 1.9% by mass or less, may be 1.8% by mass or less, and may be 1.7% by mass or less. It should be noted that the amount of Ni may be 0% by mass.

### (Amount of Si)

Si is adjusted so that the mass ratio (Ni+Co)/Si is 3 to 5. With the above ratio, both strength and electrical conductivity after precipitation hardening can be improved. When the above ratio exceeds 5, precipitation of Co₂Si and Ni₂Si during aging treatment becomes insufficient, resulting in a decrease in strength. When the above ratio is less than 3, Si that did not precipitate as Co₂Si or Ni₂Si is dissolved in the matrix, resulting in a decrease in electrical conductivity.

### (Amounts of Ag, Cr, Mn, Sn, P, B, Zr, Ti, Mg, Al, Fe and Zn)

When added in small amounts, Ag, Cr, Mn, Sn, Zr, Ti, Mg, Al, Fe, and Zn can improve product properties such as strength and stress relaxation properties without impairing electrical conductivity. P has a deoxidizing effect, B has an effect of refining the casting structure, and Mn has an effect of improving hot workability. The effect of addition is mainly exhibited by solid solution in the parent phase, but it can also be more effective by being included in the second phase particles.

In some embodiments of the present invention, Ag, Cr, Mn, Sn, P, B, Zr, Ti, Mg, Al, Fe, and Zn may be added at a total concentration greater than 1.0% by mass. However, from the viewpoint of preventing deterioration of electrical conductivity and bending properties and maintaining manufacturability, in a preferred embodiment of the present invention, the copper alloy comprises at least one selected from Ag, Cr, Mn, Sn, P, B, Zr, Ti, Mg, Al, Fe, and Zn in a total amount of 1.0% by mass or less.

Further, the total amount of Ag, Cr, Mn, Sn, P, B, Zr, Ti, Mg, Al, Fe, and Zn added is more preferably 0.7% by mass or less, and even more preferably 0.5% by mass or less. However, if the total content of Ag, Cr, Mn, Sn, P, B, Zr, Ti, Mg, Al, Fe and Zn is less than 0.01% by mass, their effect tends to be small, so it is more preferable that the total amount of Ag, Cr, Mn, Sn, P, B, Zr, Ti, Mg, Al, Fe, and Zn is 0.01% by mass or more. Further, the total amount of them is more preferably 0.05% by mass or more, and even more preferably 0.1% by mass or more.

In the present embodiment, the remainder other than the components mentioned above are Cu and inevitable impurities. Here, the inevitable impurities mean impurity elements that are inevitably mixed into the material during the manufacturing process. The concentration of the inevitable impurities can be, for example, 0.10% by mass or less, and preferably 0.05% by mass or less.

### (Average Taylor Factor)

The Taylor factor is an index representing the ease of plastic deformation in consideration of multiple slip systems of a polycrystalline body, and is a value determined by the stress direction and crystal orientation distribution. Assuming the yield stress of the polycrystalline body is σ_{y}, and the critical resolved shear stress of the crystal is τ_{CRSS}, the Taylor factor M is expressed as σ_{y}=M*τ_{CRSS}. The smaller the Taylor factor is, the smaller the yield stress is required to cause sliding deformation, and the easier it is to cause plastic deformation. The inventor has discovered that, when bending process in the Bad way direction (bending direction with the center axis of bending in the direction parallel to the rolling direction) is considered to be plane strain deformation with the main strain direction being in the direction perpendicular to the rolling direction, by controlling the value of the calculated Taylor factor within a predetermined range, a material with suitable bending workability can be obtained. In the present invention, the method for measuring the average Taylor factor is shown below.

Using a sample whose rolled surface was electrolytically polished with 10 μm in a solution of 67% phosphoric acid+10% sulfuric acid, EBSD (Electron Back Scatter Diffraction) measurement is performed. The normal direction (ND direction) of the rolled surface of the sample is tilted at 70° with respect to the incident electron beam. With an accelerating voltage: 15.0 kV, an irradiation current amount: 1.5×10⁻⁸ A, a working distance: 15 mm, measurement is performed on a 500 μm×500 μm area in 1 μm steps. As the measuring device, JSM-IT500HR manufactured by JEOL Ltd. is used. OIM Analysis 8 provided by TSL Solutions is used as the analysis program. A strain tensor representing a deformed state in which the plate is elongated in the direction perpendicular to the rolling direction and the plate thickness decreases is set, and the average value of the Taylor factor within the measurement field of view is calculated.

In the present invention, in order to obtain suitable bending workability, it is necessary to control the average Taylor factor to 3.5 or less under plane strain that elongates in the direction perpendicular to the rolling direction and reduces the plate thickness. From the viewpoint of further improving bending workability, the average Taylor factor under plane strain that elongates in the direction perpendicular to the rolling direction and reduces the plate thickness is preferably 3.45 or less, more preferably 3.4 or less, even more preferably 3.35 or less, even more preferably 3.3 or less, and even more preferably 3.25 or less.

### (Crystal Grain Size)

By reducing the crystal grain size, a material with suitable bending workability can be obtained. In the present invention, in order to obtain suitable bending workability, it is necessary to control the crystal grain size to 10 μm or less. From the viewpoint of further improving bending workability, the crystal grain size is preferably 9.5 μm or less, more preferably 9.0 μm or less, even more preferably 8.5 μm or less, even more preferably 8.0 μm or less, and even more preferably 7.5 μm or less.

The average crystal grain size is calculated in the Intercept Lengths mode of the analysis program using the data obtained by the EBSD measurement of the rolled surface as described above. Specifically, the average intercept length in the direction parallel to the rolling direction and the direction perpendicular to the rolling direction is calculated, and the average value of both is taken as the average crystal grain size. At this time, grain boundaries with a misorientation of 15° or more are regarded as grain boundaries, and grain boundaries corresponding to Σ3 are excluded from the grain boundaries.

### (0.2% Yield Stress)

In order to satisfy the characteristics required for specified electronic materials such as connectors, the 0.2% yield stress in the rolling direction is 700 MPa or more, more preferably 710 MPa or more, even more preferably 720 MPa or more, even more preferably 730 MPa or more, even more preferably 740 MPa or more, and even more preferably 750 MPa or more. Although the upper limit of 0.2% yield stress is not particularly regulated, it is typically 850 MPa or less in order to achieve an electrical conductivity of 50% IACS or more.

For the 0.2% yield stress, a JIS No. 13B test piece is prepared so that the tensile direction is parallel to the rolling direction, and it can be measured by performing a tensile test parallel to the rolling direction using a tensile tester in accordance with JIS Z 2241 (2011).

### (Electrical Conductivity)

The electrical conductivity in the rolling direction is 50% IACS (International Annealed Copper Standard) or more. Thereby, it can be effectively used as an electronic material. The electrical conductivity can be measured by taking a test piece so that its longitudinal direction is parallel to the rolling direction and using a four-probe method in accordance with JIS H 0505 (1975). The electrical conductivity in the rolling direction is preferably 51% IACS or more, more preferably 52% IACS or more, even more preferably 53% IACS or more, even more preferably 54% IACS or more, and even more preferably 55% IACS or more.

### (Manufacture Method)

An example of a preferred method for manufacturing a Cu—Co—Ni—Si alloy according to the present invention will be explained step by step.

The Cu—Co—Ni—Si alloy as described above can be manufactured by sequentially performing the following steps: an ingot production process, a homogenization annealing process, a hot rolling process, a first intermediate cold rolling process, an intermediate annealing process, a second intermediate cold rolling process, a solution treatment process, an aging treatment process, and a final cold rolling process. In addition, after the hot rolling, it is possible to perform surface cutting if necessary.

### <Ingot Production>

Melting and casting is generally performed in an atmospheric melting furnace, but it can also be performed in a vacuum or in an inert gas atmosphere. After melting an electrolytic copper, raw materials such as Co, Ni, and Si are added according to the composition of each sample, and after stirring, the melt is maintained for a certain period of time to obtain a molten metal with a desired composition. Then, after adjusting the temperature of this molten metal to 1250° C. or higher, it is cast into an ingot. In addition to Co, Ni, and Si, at least one selected from Ag, Cr, Mn, Sn, P, B, Zr, Ti, Mg, Al, Fe, and Zn can also be added so that the total amount is 1.0% by mass or less.

### <Homogenization Annealing/Hot Rolling>

Coarse crystallized substances may be produced during the solidification process during casting, and coarse precipitates may be produced during the cooling process. By performing homogenization annealing at an appropriate temperature and time and then hot rolling, these second phase particles are re-dissolved in the parent phase. If the homogenization annealing temperature is too high, the material may melt, which is not preferable. Specifically, the homogenization annealing temperature is preferably 950 to 1025° C., and the homogenization annealing time is preferably 1 to 24 hours. In the cooling process after hot rolling, it is preferable to make the cooling rate as fast as possible to suppress precipitation of second phase particles.

### <First Intermediate Cold Rolling>

A first intermediate cold rolling is performed on the copper alloy material after the hot rolling process. Here, the working degree of the first intermediate cold rolling can be 30 to 98%. The working degree is an amount calculated by (h₁−h₂)/h₁*100%, where h₁ and h₂ are the thicknesses of the material before and after the rolling, respectively.

### <Intermediate Annealing/Second Intermediate Cold Rolling>

The intermediate annealing precipitates a certain amount of second phase particles in the alloy, and the second intermediate cold rolling imparts strain that becomes the driving force for subsequent recrystallization. By changing the precipitation state and strain amount of the second phase particles, the recrystallized texture formed in the subsequent solution treatment changes. By appropriately adjusting the intermediate annealing temperature in the range of 500 to 1000° C. and the working degree of the second intermediate cold rolling in the range of 50 to 99%, the average Taylor factor and grain size can be controlled, and a recrystallized texture that is advantageous for bending can be formed.

### <Solution Treatment>

Next, a solution treatment is performed. The purpose of the solution treatment is to form a recrystallized texture and to dissolve the additive elements. If the solution treatment temperature is too low, the desired recrystallized texture may not be obtained, and the amount of solid solution of the added element will decrease, making it impossible to obtain a sufficient amount of age hardening, resulting in a decrease in product strength. Further, if the solution treatment temperature is too high, the crystal grains will become coarse and the strength of the product will decrease. Therefore, the solution treatment temperature is preferably 850 to 1000° C. and the holding time is preferably 5 to 300 seconds.

### <Aging Treatment>

Next, an aging treatment is performed. By performing the aging treatment, precipitates of appropriate size are uniformly distributed and the desired strength and electrical conductivity can be obtained. The aging treatment temperature is preferably set to 400 to 550° C., because if the maximum temperature is lower than 400° C., the electrical conductivity may be low, and if the maximum temperature is higher than 550° C., the strength may be reduced. Further, the total time of the aging treatment is preferably 1 to 24 hours. The aging treatment is preferably carried out in an inert atmosphere such as Ar, N₂, H₂, or the like in order to suppress the formation of an oxide film.

### <Final Cold Rolling>

By performing a final cold rolling subsequent to the aging treatment, dislocations can be introduced into the alloy and strength can be increased. The higher the working degree of rolling is, the higher the strength of the material obtained is, but if the working degree of rolling is too high, the bending workability tends to be impaired. Therefore, in order to obtain a good balance between strength and bending workability, the working degree of rolling can be set to 10 to 50%, preferably 20 to 40%.

Incidentally, in between the above-mentioned steps, process such as grinding, polishing, shot blast pickling, or the like for removing oxide scale on the surface can be performed as appropriate.

The Cu—Co—Ni—Si alloy of the present invention can be processed into various copper products such as plates, strips, tubes, rods, and wires. Further, this Cu—Co—Ni—Si alloy can be used for electronic parts such as lead frames, connectors, pins, terminals, relays, switches, and foil materials for secondary batteries.

### Examples

Examples of the present invention will be shown below along with Comparative Examples, but these Examples are provided to better understand the present invention and its advantages, and are not intended to limit the invention.

Copper alloys having the respective component compositions (unit: % by mass) shown in Table 1 were melted at 1300° C. using a high frequency melting furnace, and cast into ingots with a thickness of 30 mm. Next, this ingot was subjected to homogenization annealing at 980° C. for 3 hours, then hot rolled to a thickness of 10 mm and immediately cooled with water. Then, after performing a first intermediate cold rolling, an intermediate annealing and a second intermediate cold rolling were performed. Table 2 shows the conditions of the intermediate annealing and the second intermediate cold rolling of Inventive Example 1 and Comparative Example 1. For Inventive Examples 2 to 4 and Comparative Examples 2 to 7, the intermediate annealing temperature was adjusted to 500 to 1000° C., and the working degree of the second intermediate cold rolling was adjusted within the range of 50 to 99% based on the following knowledge, so that the average Taylor factor and crystal grain size became predetermined values.

### Intermediate Annealing:

When the intermediate annealing temperature is high, the number density of the second phase particles in the alloy becomes large, so that the pinning effect of the second phase particles on the grain boundaries becomes effective and the crystal grain size becomes small. On the other hand, the growth of recrystallized textures (for example, Cube orientation {100}<001> and BR orientation {236}<385>) that are advantageous for bending in the BW direction (Bad Way, direction in which the bending axis is parallel to the rolling direction) is inhibited, so the average Taylor factor becomes high. When the intermediate annealing temperature is low, the number density of the second phase particles in the alloy becomes small, so that the pinning effect of the second phase particles on the grain boundaries becomes insufficient and the crystal grain size becomes large, and on the other hand, since a recrystallized texture advantageous for bending in the BW direction develops, the average Taylor factor becomes low.

### Second Intermediate Cold Rolling:

When the working degree of the second intermediate cold rolling is low, sufficient working strain is not applied, so the frequency of generation of recrystallization nuclei decreases, and the crystal grain size increases. When working degree of the second intermediate cold rolling is high, the average Taylor factor becomes high because the growth of recrystallized texture, which is advantageous for bending in the BW direction, is inhibited.

Thereafter, a solution treatment was performed at 950° C. for 160 seconds, and an aging treatment was performed for a total of 24 hours at a maximum temperature of 520° C. Next, after the aging treatment, a final cold rolling was performed with a rolling working degree of 25% to prepare a sample with a thickness of 0.2 mm.

TABLE 1

| | | | | | Crystal | | 0.2% yield | | |
|---|---|---|---|---|---|---|---|---|---|
| | | | | (Ni + Co)/ | grain size | Taylor | stress | Conductivity | MBR/t |
| | Co | Ni | Si | Si | (μm) | fabot | (MPa) | (% IACS) | @BW |
| Inventive | 1.6 | 0.5 | 0.48 | 4.4 | 9.8 | 3.25 | 752 | 56 | 0 |
| Example 1 | | | | | | | | | |
| Inventive | 1.6 | 0.5 | 0.48 | 4.4 | 9.1 | 3.38 | 765 | 55 | 0 |
| Example 2 | | | | | | | | | |
| Inventive | 1.6 | 0.5 | 0.48 | 4.4 | 6.4 | 3.34 | 749 | 55 | 0 |
| Example 3 | | | | | | | | | |
| Inventive | 1.6 | 0.5 | 0.48 | 4.4 | 7.1 | 3.42 | 747 | 56 | 0 |
| Example 4 | | | | | | | | | |
| Comparative | 1.6 | 0.5 | 0.48 | 4.4 | 14.1 | 3.45 | 726 | 55 | 3 |
| Example 1 | | | | | | | | | |
| Comparative | 1.6 | 0.5 | 0.48 | 4.4 | 3.7 | 3.68 | 731 | 56 | 2 |
| Example 2 | | | | | | | | | |
| Comparative | 1.6 | 0.5 | 0.48 | 4.4 | 6.7 | 3.56 | 748 | 53 | 3 |
| Example 3 | | | | | | | | | |
| Comparative | 1.6 | 0.5 | 0.48 | 4.4 | 5.5 | 3.66 | 738 | 55 | 2 |
| Example 4 | | | | | | | | | |
| Comparative | 1.6 | 0.5 | 0.48 | 4.4 | 24.9 | 3.41 | 695 | 56 | 3 |
| Example 5 | | | | | | | | | |
| Comparative | 1.6 | 0.5 | 0.48 | 4.4 | 11.9 | 3.43 | 758 | 55 | 1 |
| Example 6 | | | | | | | | | |
| Comparative | 1.6 | 0.5 | 0.48 | 4.4 | 11.1 | 3.58 | 745 | 55 | 5 |
| Example 7 | | | | | | | | | |

TABLE 2

| | Intermediate annealing | Second intermediate rolling |
|---|---|---|
| | temperature (° C.) | working degree (%) |
| Inventive | 800 | 93 |
| Example 1 | | |
| Comparative | 500 | 56 |
| Example 1 | | |

The following characteristics were evaluated for each test piece thus obtained. The evaluation results are shown in Table 1.

### (Average Taylor Factor)

The rolled surfaces of the copper alloy samples of each Inventive Example and Comparative Example were electrolytically polished with 10 μm in a solution of 67% phosphoric acid and 10% sulfuric acid. Then, EBSD (Electron Back Scatter Diffraction) measurement was performed. The normal direction (ND direction) of the rolled surface of the sample as tilted at 70° with respect to the incident electron beam. With an accelerating voltage: 15.0 kV, an irradiation current amount: 1.5×10⁻⁸ A, a working distance: 15 mm, measurement was performed on a 500 μm×500 μm area in 1 μm steps. As the measuring device, JSM-IT500HR manufactured by JEOL Ltd. was used. OIM Analysis 8 provided by TSL Solutions was used as the analysis program. A strain tensor representing a deformed state in which the plate is elongated in the direction perpendicular to the rolling direction and the plate thickness decreases was set, and the average value of the Taylor factor within the measurement field of view was calculated.

### (Crystal Grain Size)

Using the data obtained by the EBSD measurement of the rolled surface described above, the average crystal grain size was calculated in the Intercept Lengths mode of the analysis program. Specifically, the average intercept length in the direction parallel to the rolling direction and the direction perpendicular to the rolling direction was calculated, and the average value of both was taken as the average crystal grain size. In addition, grain boundaries with a misorientation of 15° or more were regarded as grain boundaries, and grain boundaries corresponding to Σ3 were excluded from the grain boundaries.

### (0.2% Yield Stress)

For the 0.2% yield stress, a JIS No. 13B test piece was prepared so that the tensile direction was parallel to the rolling direction, and it was measured by performing a tensile test parallel to the rolling direction using a tensile tester in accordance with JIS Z 2241 (2011).

### (Electrical Conductivity)

For the electrical conductivity (EC: % IACS), a test piece was taken so that the longitudinal direction of the test piece was parallel to the rolling direction, and measured by a four-probe method in accordance with JIS H 0505 (1975).

### (Bending Workability)

A W bending test was conducted in the BW direction (Bad Way, the direction in which the bending axis is parallel to the rolling direction) in accordance with JIS H 3130 (2018). The minimum bending radius (MBR, unit: mm) without cracking was determined, and the ratio (MBR/t) to the plate thickness (t, unit: mm) was measured. It is preferable that the value of MBR/t is small because it can withstand a smaller bending radius. An MBR/t of 0 indicates that no cracks occur even if the bending radius is 0 mm.

As shown in Table 1, in each Inventive Example, by performing intermediate annealing and second intermediate cold rolling under predetermined conditions, the average Taylor factor under plane strain that elongates in the direction perpendicular to rolling and reduces the plate thickness was 3.5 or less, the crystal grain size was 10 μm or less, the 0.2% yield stress in the rolling direction was 700 MPa or more, and the electrical conductivity in the rolling direction was 50% IACS or more.

In Comparative Examples 2 to 4 and 7, the average Taylor factor exceeded 3.5, resulting in poor bending workability.

In Comparative Examples 1 and 5 to 7, the crystal grain size of the copper alloys obtained exceeded 10 μm, resulting in poor bending workability.

As described above, according to the present disclosure, it is possible to provide a highly reliable copper alloy for electronic materials that has a 0.2% yield stress and an electrical conductivity suitable for electronic material applications, and has improved bending workability.

### INDUSTRIAL APPLICABILITY

According to the present invention, it is possible to provide a highly reliable copper alloy for electronic materials that has a 0.2% yield stress and an electrical conductivity suitable for electronic material applications, and has improved bending workability, and it is possible to provide an electronic component equipped with such copper alloy for electronic materials.

1. A copper alloy for electronic materials, in which an amount of Ni is 1.0% by mass or less, the copper alloy comprising 0.5 to 2.5% by mass of Co, and comprising Si such that a mass ratio (Ni+Co)/Si is 3 to 5, the remainder consisting of copper and inevitable impurities, wherein an average Taylor factor under plane strain that elongates in a direction perpendicular to a rolling direction and reduces plate thickness is 3.5 or less, a crystal grain size is 10 μm or less, and a 0.2% yield stress in the rolling direction is 700 MPa or more, and an electrical conductivity in the rolling direction is 50% IACS or more.

2. The copper alloy for electronic materials according to claim 1, further comprising at least one selected from Ag, Cr, Mn, Sn, P, B, Zr, Ti, Mg, Al, Fe, and Zn in a total amount of 1.0% by mass or less.

3. An electronic component, comprising the copper alloy for electronic materials according to claim 1.

4. An electronic component, comprising the copper alloy for electronic materials according to claim 2.
